(19) United States
(12) Patent Application Publication
(10) Pub. No.: US 2026/0347188 A1
(43) Pub. Date: Nov. 5, 2026

(54) Process for Preparing a Liquid Phosphate Composition and a Process for Preparing a Dicalcium Phosphate Composition

(71) Applicant: PRAYON, Engis (BE)

(72) Inventors: Thomas DETHIER, Engis (BE); Marc SONVEAUX, Engis (BE); Thomas HENRY, Engis (BE)

(73) Assignee: PRAYON, Engis (BE)

(21) Appl. No.: 19/486,460

(22) PCT Filed: May 22, 2024
(86) PCT No.: PCT/EP2024/064061

§ 371 Date: Nov. 21, 2025

(30) Foreign Application Priority Data
May 24, 2023 (EP) 23175123.1

(51) Int. Cl. C01B 25/32; C01B 25/22

(52) U.S. Cl. CPC C01B 25/321; C01B 25/2212

(57) ABSTRACT

The present invention concerns a process for preparing a liquid phosphate composition; said process comprising at least the steps of providing in at least one vessel: at least one phosphate source, and either at least one MCl salt selected from the group consisting of alkali chlorides, ammonium chloride and mixtures thereof and at least one FSA source, or at least one composition (A) obtained by contacting at least one MCl salt with at least one FSA source; contacting said phosphate source with either said MCl salt and said FSA source, or with said composition (A), thereby forming at least one slurry comprising at least one solid residue and a liquid phosphate composition; separating said solid residue from said liquid phosphate composition.

### FIELD OF THE INVENTION

The present invention concerns a process for preparing a liquid phosphate composition. More specifically, the field of the present invention is the field of phosphate production through an acid attack of a phosphate source.

### BACKGROUND

Fluosilicic acid (FSA, H₂SiF₆) is an acid which is often obtained as a by-product in the production of phosphoric acid from phosphate sources comprising fluoroapatite. Indeed, phosphoric acid is often produced through a wet process comprising a digestion step of a phosphate source with a mineral acid such as hydrochloric acid or sulfuric acid. When the phosphate source is digested, fluorine is released and forms hydrofluoric acid which reacts with the silica present within the phosphate source to produce fluosilicic acid. Then, under the action of heat, the fluosilicic acid decomposes into silicon tetrafluoride and hydrogen fluoride. The SiF₄ gas is then captured during water washing and transformed into fluosilicic acid.

Usually, fluosilicic acid is then most of the time neutralised and then disposed of as a waste product or rejected to the environment. There is thus a need to valorise fluosilicic acid.

U.S. Pat. No. 11,560,310 B1 proposed a process wherein FSA is used directly to digest a phosphate source. More specifically, the process comprises a reaction between FSA and a calcium phosphate source to produce phosphoric acid and calcium fluoride followed by a neutralisation step wherein the phosphoric acid produced is reacted with a calcium source in order to produce dihydrate di-calcium phosphate.

The digestion step is often followed by a solid/liquid separation step such as a filtration step of the obtained slurry. However, it was observed that filtration of a slurry obtained either by attacking a phosphate source with dilute HCI or dilute FSA alone is very difficult and cannot be easily performed using a filtration device, which has a negative impact on the industrial implementation of the process.

There is thus a need for a process for preparing a liquid phosphate composition which enables valorising FSA while guarantying good filterability.

### SUMMARY OF THE INVENTION

The inventors have surprisingly found that the process according to the present invention overcomes the above identified problems of the prior art.

The present invention concerns a process for preparing a liquid phosphate composition; said process comprising at least the steps of:
(i) providing in at least one vessel:
   at least one phosphate source, and
   either at least one salt selected from the group consisting of alkali chlorides, ammonium chloride and mixtures thereof [hereafter, MCl salt] and at least one fluosilicic acid [hereafter FSA] source, or
   at least one composition [hereafter, composition (A)] obtained by contacting at least one MCl salt with at least one FSA source;
(ii) contacting said phosphate source with either said MCl salt and said FSA source, or with said composition (A), thereby forming at least one slurry comprising at least one solid residue and a liquid phosphate composition;
(iii) separating said solid residue from said liquid phosphate composition; wherein the nH/nCa ratio is of at least 1.0, wherein nH is either the total amount of moles of hydrogen atoms either from the FSA comprised in said FSA source provided in step (i) or from the FSA comprised in said FSA source used to obtain said composition (A), and nCa is the total amount of moles of Ca atoms comprised in said phosphate source provided in step (i); and wherein the nMCl/nFSA ratio is of at least 1.80; wherein nMCl is the total amount of moles of MCl salt provided in step (i) or used to obtained said composition (A) and nFSA is the total amount of moles of FSA comprised in said FSA source provided in step (i) or used to obtained said composition (A).

The present invention also concerns a process for preparing a dicalcium phosphate composition [hereafter, DCP composition] comprising at least the steps (i), (ii) and (iii) as defined for the process for preparing a liquid phosphate composition and further comprising at least:
a step (iv) of contacting at least one basic composition comprising at least one calcic compound with said at least one liquid phosphate composition obtained in step (iii) at a pH sufficient to precipitate DCP, thereby forming at least one composition (C) comprising solid DCP.

The present invention also concerns a liquid phosphate composition obtained by the process according to the present invention.

### DETAILED DESCRIPTION

In the context of the present invention, the term “comprising” should not be interpreted as excluding features or elements other than those explicitly mentioned. It should be construed as specifying the presence of the features or elements indicated, but does not exclude the presence or addition of one or more other features or elements. Thus, the scope of the expression “a method comprising steps A and B” should not be limited to methods consisting only of steps A and B. Similarly, a composition comprising components A and B should not be limited to compositions consisting only of components A and B. Accordingly, the terms “comprising” and “including” encompass the terms more restrictive “consisting essentially of” and “consisting of”.

In the context of the present invention, if an element or component is said to be selected from a list of recited elements or components, it should be understood that the element or component can also be any one of the individual recited elements or components in said list, or can also be selected from a group consisting of any two or more of the explicitly listed elements or components.

Furthermore, the terms “first”, “second”, “third” and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Although the steps of the process according to the present invention are designated with roman numerals such as for example (i), (ii) and (iii), it does not mean that a given step must be finished before the subsequent step is carried out. For example, it is not required that step (i) must be completely finished before step (ii) is carried out. Preferably, steps (i) and (ii) are carried out at least partially at the same time.

Furthermore, the various embodiments, although referred to as “preferred” are to be construed as exemplary manners in which the invention may be implemented rather than as limiting the scope of the invention.

Unless stated otherwise, all the percentages and parts per million (ppm) concentrations are respectively percentages by weight (=wt. %) and ppm in weight (=ppm).

Within the context of the present invention, FSA is intended to denote fluosilicic acid. The terms fluosilicic acid, fluorosilicic acid, fluosilic acid and hexafluorosilicic acid can be used interchangeably. Within the context of the present invention, it is considered that FSA has the formula H₂SiF₆.

As explained above, the present invention concerns a process for preparing a liquid phosphate composition. The term “liquid phosphate composition” is intended to denote a composition in liquid form (for example an aqueous solution) comprising phosphate ions. Said phosphate ions may include for example PO₄³⁻HPO₄²⁻ and H₂PO₄⁻ ions. Preferably, said liquid phosphate composition comprises H₃PO₄ and ions such as H₂PO₄⁻, Ca⁺⁺ and H₃O⁺.

Thus, said liquid phosphate composition may comprise at least one phosphate salt and/or phosphoric acid. Preferably, said phosphate salt is a soluble phosphate salt, preferably monocalcium phosphate (MCP). Said soluble phosphate salt or MCP may at least partially or totally be dissociated in solution.

Preferably, said liquid phosphate composition comprises, based on the total weight of said liquid phosphate composition, at least 0.5 wt. %, more preferably at least 1 wt. %, even more preferably at least 2 wt. % of phosphorus expressed as P₂O₅ equivalents. Preferably, said liquid phosphate composition comprises, based on the total weight of said liquid phosphate composition, at most 20 wt. %, more preferably at most 15 wt. %, even more preferably at most 10 wt. %, even more preferably at most 7 wt. % of phosphorus expressed as P₂O₅ equivalents.

In a preferred embodiment, said liquid phosphate composition comprises based on the total weight of said composition at least 0.5 wt. % and at most 20 wt. %, more preferably at least 1 wt. % and at most 15 wt. %, even more preferably at least 2 wt. % and at most 10 wt. %, even more preferably at least 2 wt. % and at most 7 wt. % of phosphorus expressed as P₂O₅ equivalents.

Within the context of the present invention, the weight percentages of phosphorus are expressed as P₂O₅ equivalents. Within the context of the present invention all the P₂O₅ wt. % may be measured by any suitable method known in the art. Preferably all the P₂O₅ wt. % can be measured after sample preparation (for example by acid digestion when necessary) by colorimetry of phospho-vanado-molybdate (Light absorption spectrophotometry).

### Step (i)

The process according to the present comprises a step (i) of providing in at least one vessel:
at least one phosphate source, and
either at least one salt selected from the group consisting of alkali chlorides, ammonium chloride and mixtures thereof [hereafter, MCl salt] and at least one fluosilicic acid [hereafter FSA] source,
or at least one composition [hereafter, composition (A)] obtained by contacting at least one MCl salt with at least one FSA source.

Within the context of the present invention, the term “vessel” is intended to encompass any reaction vessel, reactor, tank, crystallizer, plug-flow reactors and the like.

In the context of the present invention several vessels can also be used, in series or in parallel.

Within the context of the present invention, the term “phosphate source” is intended to denote any material comprising at least one phosphate ion. Thus, suitable phosphate sources include for example without being limited to: phosphates rocks or ores comprising apatite, and/or hydroxyapatite, and/or chlorapatite, and/or fluoroapatite, whitlockite, guano, carbonate apatite, phosphate slimes or beneficiation residue, ash sludges from wastewater treatment plants, bone ashes, solid industrial wastes from the pharmaceutical or food industries.

Preferably, said phosphate source comprises at least 10 wt. %, more preferably at least 15 wt. %, even more preferably at least 20 wt. % of phosphorus expressed as P₂O₅ equivalents with regards to the total weight of said phosphate source. Preferably said phosphate source comprises at most 55 wt. %, more preferably at most 40 wt. %, even more preferably at most 35 wt. %, even more preferably at most 30 wt. % of phosphorus expressed as P₂O₅ equivalents, with regards to the total weight of said phosphate source.

In a preferred embodiment, said phosphate source comprises at least 10 wt. % and at most 55 wt. %, more preferably at least 15 wt. % and at most 40 wt. %, even more preferably at least 20 wt. % and at most 35 wt. %, even more preferably at least 20 wt. % and at most 30 wt. % of phosphorus expressed as P₂O₅ equivalents, with regards to the total weight of said phosphate source.

Preferably, said phosphate source further comprises calcium.

Preferably, said phosphate source comprises at least 1 wt. %, preferably at least 5 wt. %, more preferably at least 10 wt. %, even more preferably at least 15 wt. %, even more preferably at least 20 wt. %, even more preferably at least 30 wt. % of Ca expressed as CaO equivalents with regards to the total weight of said phosphate source. Preferably said phosphate source comprises at most 60 wt. %, more preferably at most 58 wt. %, even more preferably at most 55 wt. %, of Ca expressed as CaO equivalents, with regards to the total weight of said phosphate source.

In a preferred embodiment, said phosphate source comprises at least 10 wt. % and at most 60 wt. %, more preferably at least 15 wt. % and at most 58 wt. %, even more preferably at least 20 wt. % and at most 55 wt. %, of Ca expressed as CaO equivalents, with regards to the total weight of said phosphate source.

Within the context of the present invention, the Ca wt. % can be measured by any means known by the skilled person in the art, preferably, it can be measured by ICP-OES (Inductively Coupled Plasma Optical Emission spectroscopy), after acidic, particularly strongly acid, digestion of the sample.

Said at least one phosphate source can be grinded before said step (i). Thus, said at least one phosphate source can be provided in step (i) in powdered form or in the form of pebbles. Additionally, said at least one phosphate source can also be provided in step (i) in dry form or as a dispersion, for example in an aqueous solution (water or process water (recycled water)). If said phosphate source is a dispersion, it can comprise up to 75 wt. %, preferably up to 70 wt. % of solids based on the total weight of said phosphate source.

Said at least one MCl salt can be provided in step (i) in powered form or at least partially dissolved or dispersed in solution, such as for example an aqueous solution.

In the context of the present invention, an FSA source is a material comprising FSA. The material can be a liquid material such as a solution or solid material. Preferably, said FSA source is a solution, more preferably an aqueous solution, comprising FSA.

Preferably, said FSA source comprises at least 5 wt. %, more preferably at least 10 wt. %, even more preferably at least 13 wt. % of FSA with regards to the total weight of said FSA source. Preferably, said FSA source comprises at most 50 wt. %, more preferably at most 30 wt. %, even more preferably at most 28 wt. % of FSA with regards to the total weight of said FSA source.

Preferably, said FSA source is obtained from a phosphoric acid production process. More preferably said phosphoric acid production process is a wet process.

In a preferred embodiment, said FSA source comprises at least 5 wt. % and at most 50 wt. %, more preferably at least 10 wt. % and at most 30 wt. %, even more preferably at least 15 wt. % and at most 28 wt. % of FSA with regards to the total weight of said FSA source.

Preferably, said at least one MCl salt is selected from the group consisting of NaCI, KCI, LiCI, NH₄CI and mixtures thereof.

Within the context of the present invention, said composition (A) is obtained by contacting, preferably mixing at least one MCl salt with an FSA source. In particular, when said at least MCl salt is contacted, preferably mixed, with a FSA source, the FSA comprised in said FSA source reacts at least partially with said MCl salt according to the reaction (I) below:

2MCl+H₂SiF₆→M₂SiF₆+2HCl Reaction (I)

wherein M is an alkali metal or an ammonium cation, preferably M is selected from the group consisting of Li, Na, K, NH₄⁺ and combinations thereof.

Thus, the composition (A) can be a dispersion or a suspension.

The M₂SiF₆ formed according to Reaction (I) is an hexafluorosilicate selected from the group consisting of ammonium hexafluorosilicate, alkali metal hexafluorosilicates and mixtures thereof, wherein said alkali metal is preferably selected from the group consisting of Li, Na, K, and combinations thereof.

Thus, in other words, the FSA is at least partially converted into an hexafluorosilicate and hydrochloric acid. Thus, said composition (A) can comprise an hexafluorosilicate selected from the group consisting of ammonium hexafluorosilicate, alkali metal hexafluorosilicates and mixtures thereof, and hydrochloric acid. Said alkali metal is preferably selected from the group consisting of Li, Na, K, and combinations thereof.

According to the present invention, the nH/nCa ratio is of at least 1.0, preferably at least 1.2, more preferably at least 1.6. Preferably, said nH/nCa ratio is of at most 3.0, preferably at most 2.6. In a preferred embodiment, said nH/nCa ratio is of at least 1.0 and at most 3.0, preferably at least 1.2 and at most 2.6, more preferably at least 1.6 and at most 2.6.

The nH in said nH/nCa ratio is:
either the total amount of moles of hydrogen atoms from the FSA comprised in said FSA source provided in step (i), or
the total amount of moles of hydrogen atoms from the FSA comprised in said FSA source used to obtain said composition (A).

Within the context of the present invention, the total amount of moles of hydrogen atoms from the FSA corresponds to the total amount of moles of the 2 hydrogen atoms from H₂SiF₆. Thus, it does not include other hydrogen atoms such as the two hydrogen atoms from H₂O that may be contained in the FSA source.

The nCa in said nH/nCa ratio is the total amount of moles of Ca atoms comprised in said phosphate source provided in step (i).

In other words, the nH/nCa molar ratio enables to characterize the input conditions in step (i) with regards to the quantities of FSA (in said FSA source) and of Ca (in the added phosphate source).

According to the present invention, the nMCl/nFSA ratio is of at least 1.80, preferably at least 1.85, more preferably at least 1.90, even more preferably at least 2.00, even more preferably at least 2.10, even more preferably at least 2.15, even more preferably at least 2.18, even more preferably at least 2.20, even more preferably at least 2.22. Preferably, the nMCl/nFSA ratio is of at most 5.00, preferably at most 4.00, more preferably at most 3.00, even more preferably at most 2.60.

In a preferred embodiment, the nMCl/nFSA ratio is of at least 1.80 and at most 5.00, preferably at least 1.90 and at most 4.00, more preferably at least 2.15 and at most 3.00, even more preferably at least 2.20 and at most 2.60.

The nMCl in said nMCl/nFSA ratio is:
either the total amount of moles of MCl salt provided in step (i), or
the total amount of moles of MCl salt used to obtained said composition (A).

The nFSA in said nMCl/nFSA ratio is:
either the total amount of moles of FSA comprised in said FSA source provided in step (i), or
the total amount of moles of FSA comprised in said FSA source used to obtained said composition (A).

In other words, the nMCl/nFSA molar ratio enables to characterize the input conditions in step (i) with regards to the quantities of FSA (in said FSA source) and of MCl.

### Step (II)

According to the present invention, in step (ii), said phosphate source is contacted:
either with said MCl salt and said FSA source (provided in step (I)), or
with said composition (A) (provided in step (I)), thereby forming at least one slurry comprising at least one solid residue and a liquid phosphate composition.

Within the context of the present invention, the term “contacting” encompasses “mixing”, thus step (ii) can preferably be a mixing step.

When said MCl salt and said FSA source are contacted during step (ii), the reaction (I) described above occurs which results in the formation of an hexafluorosilicate selected from the group consisting of ammonium hexafluorosilicate, alkali metal hexafluorosilicates and mixtures thereof, and hydrochloric acid in situ. The hydrochloric acid is then available to digest the phosphate source.

Thus, said slurry formed in step (ii) comprises a solid residue and a liquid phosphate composition.

The solid residues can comprise solid impurities, such as F, Al, Fe, heavy metals, Si, organic impurities, radioactive elements. The solid residue can comprise based on the total weight of said residue at least 10 wt. %, preferably at least 20 wt. %, more preferably at least 30 wt. %, even more preferably at least 40 wt. %, even more preferably at least 50 wt. % of an hexafluorosilicate selected from the group consisting of ammonium hexafluorosilicate, alkali metal hexafluorosilicates and mixtures thereof.

Said alkali metal is preferably selected from the group consisting of Li, Na, K and combinations thereof.

Steps (i) and (ii) can occur at least partially at the same time.

Steps (i) and/or (ii) can be carried out at a temperature of at least 15 °C, preferably at least 18 °C, more preferably at least 20 °C, even more preferably at least 25 °C, even more preferably at least 30 °C, even more preferably at least 35 °C, even more preferably at least 40 °C. Steps (i) and/or (ii) can be carried out at a temperature of at most 110 °C, preferably at most 105 °C, more preferably at most 100 °C, even more preferably at most 90 °C, even more preferably at most 80 °C, even more preferably at most 70 °C, even more preferably at most 60 °C, even more preferably at most 50 °C.

Thus, in step (ii), said phosphate source can be contacted with said MCl salt and said FSA source or with said composition (A) preferably at a temperature of at least 20 °C, more preferably at least 30 °C, even more preferably at least 40 °C, thereby forming at least one slurry. In step (ii), said phosphate source can be contacted with said MCl salt and said FSA source or with said composition (A) preferably at a temperature of at most 80 °C, preferably at most 60 °C, more preferably at most 50 °C, thereby forming at least one slurry. In particular, the “temperature” is the temperature of the medium resulting from the contacting of said phosphate source with said MCl salt and said FSA source or with said composition (A).

Preferably, the time between the beginning of said step (ii) and the beginning of said step (iii) is of at least at least 10 minutes, more preferably at least 20 minutes, even more preferably at least 30 minutes, more preferably at least 40 minutes. Preferably, the time between the beginning of said step (ii) and the beginning of said step (iii) is of at least at most 360 minutes, preferably at most 300 minutes, more preferably at most 240 minutes, even more preferably at most 180 minutes, even more preferably at most 120 minutes, even more preferably at most 90 minutes, even more preferably at most 60 minutes. In a preferred embodiment, the time between the beginning of said step (ii) and the beginning of said step (iii) is of at least at least 10 minutes and at most 120 minutes, more preferably at least 20 minutes and at most 90 minutes, even more preferably at least 30 minutes and at most 60 minutes, more preferably at least 40 minutes and at most 60 minutes.

### Step (III)

According to the present invention, step (iii) is a solid/liquid separation step of said at least one slurry, thereby obtaining a liquid phosphate composition. Said liquid phosphate composition is preferably a phosphate solution, which preferably comprises at least one phosphate salt and/or phosphoric acid. Preferably, said phosphate salt is a soluble phosphate salt, preferably monocalcium phosphate (MCP). Thus, said soluble phosphate salt or MCP may at least partially or totally be in dissociated form in solution. In particular, said liquid phosphate composition, preferably said phosphate solution, may comprise MCP, H₃PO₄ and H₂PO₄⁻, Ca⁺⁺ and H₃O⁺ ions.

A solid residue can also be obtained. The solid residues can comprise solid impurities, such as F, Al, Fe, heavy metals, Si, organic impurities, radioactive elements. The solid residue can comprise, based on the total weight of said solid residue, at least 10 wt. %, preferably at least 20 wt. %, more preferably at least 30 wt. %, even more preferably at least 40 wt. %, even more preferably at least 50 wt. % of an hexafluorosilicate selected from the group consisting of ammonium hexafluorosilicate, alkali metal hexafluorosilicates and mixtures thereof.

Said alkali metal is preferably selected from the group consisting of Li, Na, K and combinations thereof.

Said solid/liquid separation step can be carried out by any means known by the skilled in the art. Preferably said solid/liquid separation step can be a filtration or through settling and decantation. Thus, said solid/liquid separation step can be carried out by using for example a press filter, a vacuum filter, a centrifuge decanter, a hydrocyclone, a decanter and the like.

It was surprisingly found that when said step (iii) is a filtration step, the conjoin use of either said at least one MCl salt and at least one FSA source, or said at least one composition (A) improves the filtration step. Without being bound to a theory, the inventors believe that the alkali metal and/or ammonium hexafluorosilicate formed during said step (ii) improves the filterability of the slurry and of the resulting solid residue forming the filtration cake.

The filterability rate can be defined as the quantity of slurry filtered per unit of area and per unit of time. At laboratory scale, it is determined by measuring the time needed to filter a defined quantity of slurry on a defined filtration area. It can be expressed as grams of filtered slurry/dm²/s. The “dm²” represents the surface of the filter and “s” represents the filtration time in seconds.

Additionally, the formation of the hexafluorosilicate also has the benefit to neutralize the fluorine and avoid fluorine contamination of the obtained liquid phosphate, especially when the MCl salt is in excess.

Thus, said liquid phosphate composition preferably comprises based on the total weight of said liquid phosphate composition, at most 4 wt. %, preferably at most 3 wt. %, more preferably at most 2 wt. %, more preferably at most 1 wt. %, more preferably at most 0.75 wt. % of F.

Within the context of the present invention, the wt. % of F can be measured by potentiometric method with an ion selective electrode.

### Additional steps

The process according to the present invention is not limited to said steps (i), (ii) and (iii) and can comprise additional steps.

The process according to the present invention can comprise one or more addition of a solution of hydrochloric acid during steps (i) and/or (ii) and/or (iii).

Furthermore, basic compounds may be added to the liquid phosphate composition obtained in step (iii). The addition of one or more basic compound aims to neutralize the phosphoric acid which can be present in said liquid phosphate composition and precipitate phosphate salts.

The one or more basic compound may be a source of Mg, Ca, Na, K, NH₃ and their mixture. Preferred basic compounds include but are not limited to: CaCO₃, CaO, Ca(OH)₂ and mixtures thereof.

### Process for Preparing a Dicalcium Phosphate Composition

A dicalcium phosphate (DCP) can also be obtained from the said liquid phosphate composition. Thus, the present invention also concerns a process for preparing a solid DCP composition. Said process for preparing a solid DCP composition comprises a step of providing a liquid phosphate composition obtained by the process according to the invention as defined above. Said process for preparing a solid DCP composition can comprise at least the steps (i), (ii) and (iii) as defined above. In addition, said process for preparing a solid DCP composition can further comprise a step (iv) of contacting at least one basic composition, preferably comprising at least one calcic compound with said at least one liquid phosphate composition at a pH sufficient to precipitate DCP, thereby forming at least one composition (C) comprising at least one solid DCP composition and a liquid phase.

Preferably, said pH in step (iv) is of at least 1, preferably at least 1.5, more preferably at least 2, even more preferably at least 3.

Preferably, the pH in step (iv) is of at most 6, preferably at most 5, more preferably at most 4.

Preferably, the CaO/P₂O₅ molar ratio during step (iv) is of at least 1.9; preferably at least 2, preferably less than 2.1.

The CaO in the CaO/P₂O₅ molar ratio in step (iv) represents the moles or molar concentration of Ca atoms expressed as CaO equivalents. The P₂O₅ in the CaO/P₂O₅ molar ratio in step (iv) represents the moles or molar concentration of phosphorus atoms expressed as P₂O₅ equivalents

Preferably, the pH sufficient to precipitate DCP is of at least 1 and at most 6, preferably at least 1.5 and at most 5, more preferably at least 2 and at most 4, even more preferably at least 3 and at most 4.

Within the context of the present invention, a basic composition is given its normal meaning in the art. Particularly, a basic composition can be defined as a composition which, when added into an aqueous solution, will increase the pH of said aqueous solution, particularly above pH 7.

Within the context of the present invention, a calcic compound is intended to denote a compound comprising at least one calcium cation. Within the context of the present invention, any suitable calcic compound can be used. Suitable calcic compounds include but are not limited to: CaCO₃, CaO, Ca(OH)₂ and mixtures thereof.

step (iv) can be considered as a neutralisation step which enables to obtain fertilizers, animal feed or phosphate source for a phosphoric acid wet production process.

Within the context of the present invention said at least one basic composition comprising at least one calcic compound is sometimes referred to said/the at least one basic composition or said/the basic composition.

In step (iv), the basic composition comprising at least one calcic compound may be in any suitable form such as in solid form or in solution or as a slurry.

Preferably, said basic composition is in solid form and comprises based on the total weight of said basic composition at least 10 wt. %, preferably at least 20 wt. %, more preferably at least 30 wt. %, even more preferably at least 40 wt. %, and preferably at most 99 wt. %, more preferably at most 98 wt. %, even more preferably at most 95 wt. %, of calcic compound.

Preferably, the basic composition is a solution or a dispersion [hereafter, solution (B) or dispersion (B)], more preferably an aqueous solution. Said calcic compound may be at least partially or totally dissolved in said solution (B) or dispersion (B).

Preferably, said solution (B) comprises based on the total weight of said solution (B) or dispersion (B), at last 10 wt. %, more preferably at least 20 wt. %, more even preferably at least 30 wt. % of calcic compound.

It is understood that said solution (B) or dispersion (B) preferably comprises based on the total weight of said solution (B) or dispersion (B), at most 60 wt. %, more preferably at most 50 wt. % of calcic compound.

In a preferred embodiment, said solution (B) or dispersion (B) preferably comprises based on the total weight of said solution (B) or dispersion (B), at least 10 wt. % and at most 60 wt. %, preferably at least 20 wt. % and at most 60 wt. % more preferably at least 30 wt. % and at most 50 wt. % of calcic compound.

The process for preparing a DCP composition can comprise a solid/liquid separation step of the solid DCP composition from the liquid phase comprised in said composition (C).

Said solid/liquid separation step can be carried out by using for example a press filter, a vacuum filter, a centrifuge decanter, a hydrocyclone, a decanter and the like. It is standard practice for the skilled person in the art to recycle solutions or filtrate used in any of the above steps.

The inventors have surprisingly found that the DCP obtained according to the above process presents low level of F.

Thus, said solid DCP composition preferably comprises based on the total weight of said solid DCP composition on a dry basis, at most 5 wt. %, preferably at most 4 wt. %, more preferably at most 3.5 wt. % of F.

The obtained DCP composition may be used in animal feeds, fertilizers, and phosphoric acid production.

Said solid DCP composition preferably comprises based on the total weight of said solid DCP composition on a dry basis, at most 45 wt. %, preferably at most 43 wt. %, more preferably at most 42 wt. % of phosphorus expressed as P₂O₅ equivalents.

Said solid DCP composition preferably comprises based on the total weight of said solid DCP composition on a dry basis, at least 15 wt. %, preferably at least 20 wt. %, more preferably at least 35 wt. % of phosphorus expressed as P₂O₅ equivalents.

Within the context of the present invention, DCP is intended to denote dicalcium phosphate anhydrous, dicalcium phosphate monohydrate or dicalcium phosphate dihydrate.

Within the context of the present invention, the term “total weight of said solid DCP composition on a dry basis” is intended to denote that the total weight of said solid DCP composition does not take into account free water molecules. “Free water molecules” are intended to denote water molecules that are not hydration water molecules. Hydration water molecules are also called water of crystallisation (noted .H₂O) and are water molecules which are part of the DCP crystals. Thus, if DCP is dicalcium phosphate dihydrate, the free water molecules do not include the two hydration water molecules comprised in the dicalcium phosphate dihydrate.

Said solid DCP composition preferably comprises based on the total weight of said solid DCP composition, at least 15 wt. % and at most 45 wt. %, preferably at least 20 wt. % and at most 43 wt. %, more preferably at least 35 wt. % and at most 42 wt. %, of phosphorus expressed as P₂O₅ equivalents.

The term “DCP composition” is intended to denote a composition comprising DCP.

### EXAMPLES

### Example 1

150 g of phosphate rocks (=a phosphate source), 568.3 g of an aqueous solution (=an FSA source) comprising 25 wt. % of FSA with regards to the total weight of said aqueous solution, and 126.8 g of NaCI (=MCl salt) were provided into a vessel and mixed together with 25 g of water.

The phosphate rock contained based on the total weight of said phosphate rock: 24.6 wt. % of phosphorus expressed as P₂O₅ equivalents, 1.2 wt. % of Al expressed as Al₂O₃, 0.9 wt. % of Fe expressed as Fe₂O₃, 3.2 wt. % of Mg expressed as MgO and 16.7 of wt. % Si expressed as SiO₂, 40.9 wt. % of Ca expressed CaO. Thus, the nH/nCa ratio was of 1.80 and the nMCl/nFSA ratio was of 2.20. The phosphate rock comprised apatite.

The content of the vessel was mixed for 30 min at a temperature of 50-55 °C (temperature of the content of the vessel). The obtained slurry was filtered using a Buchner filter fitted with a paper cloth of 125 mm diameter. A vacuum of 450 mmHg was applied for the filtration. The recorded filtration time in these conditions is 3 min 32 s, corresponding to a filterability of 3.2 g/dm²/s. At the end of the filtration, the obtained aqueous solution (=liquid phosphate composition) comprised, based on the weight of said aqueous solution between 2 wt. % and 7 wt. % of phosphorus expressed as P₂O₅ equivalents. The aqueous solution comprised MCP, H₃PO₄ and H₂PO₄⁻, Ca⁺⁺ and H₃O⁺ ions. The filtration cake (the solid residue) comprised between 70 wt. % and 80 wt. % of sodium hexafluorosilicate. The filtration cake also contained other solid impurities, such as F, Al, Fe, heavy metals, Si, organic impurities, radioactive elements.

### Example 2

200 g of phosphate rocks (=a phosphate source), 885 g of an aqueous solution comprising 21.4 wt. % of FSA (=an FSA source) with regards to the total weight of said aqueous solution, and 154 g of NaCI (=MCl salt) were provided into a vessel and mixed together for 30 minutes at a temperature of 60 °C.

The phosphate source had the same composition as the phosphate source used in example 1. Thus, the nH/nCa ratio was of 1.80 and the nMCl/nFSA ratio was of 2.00.

The obtained slurry was filtered using a Buchner filter (same filtration conditions with same filter as in example 1). A vacuum of 450 mmHg was applied for the filtration. The filtration time recorded was 6 min, corresponding to a filterability of 3.3 g/dm²/s. 558 g of MCP filtrate (=liquid phosphate composition) were obtained, and 565 g of wet cake were obtained. The wake was not washed, and its humidity was 50%.

The MCP filtrate contained 5.4 wt. % of phosphorus expressed as P205 equivalents based on the total weight of said MCP filtrate. The F content of the MCP filtrate was 1.24 wt. % based on the total weight of said MCP filtrate.

The MCP filtrate comprised MCP, H₃PO₄ and H₂PO₄⁻, Ca⁺⁺ and H₃O⁺ ions. The filtration cake (=the solid residue) comprised 75 wt. % of sodium hexafluorosilicate. The filtration cake also contained other solid impurities, such as F, Al, Fe, heavy metals, Si, organic impurities, radioactive elements.

DRX analysis confirms the presence of Na₂SiF₆.

### Example 3

200 g of phosphate rocks (=a phosphate source), 885 g of an aqueous solution comprising 21.4 wt. % of FSA (=an FSA source) with regards to the total weight of said aqueous solution, and 169 g of NaCl (=MCl salt) were provided into a vessel and mixed together for 60 minutes at a temperature of 60 °C.

The phosphate source had the same composition as the phosphate source used in example 1. Thus, the nH/nCa ratio was of 1.80 and the nMCl/nFSA ratio was of 2.20.

The obtained slurry was filtered using a Buchner filter (same filtration conditions with same filter as in example 1). A vacuum of 450 mmHg was applied for the filtration. The filtration time recorded was 5 min 50 s, corresponding to a filterability of 3.4 g/dm²/s. 593 g of MCP filtrate (=liquid phosphate composition) were obtained, and 565 g of wet cake were obtained. The wake was not washed, and its humidity was 43%.

The MCP filtrate contained 5.6 wt. % P₂O₅ based on the total weight of said MCP filtrate. The F content of the MCP filtrate was 0.4 wt. %, based on the total weight of said MCP filtrate.

The MCP filtrate comprised H₃PO₄ and H₂PO₄⁻, Ca⁺⁺ and H₃O⁺ ions. The filtration cake (=the solid residue) comprised 76 wt. % of sodium hexafluorosilicate. The filtration cake also contained other solid impurities, such as F, Al, Fe, heavy metals, Si, organic impurities, radioactive elements.

### Example 4—Pilot

At pilot scale, 0.97 kg/h of phosphate rocks (=a phosphate source), 3.59 kg/h of an aqueous solution comprising 25 wt. % of FSA (=an FSA source) with regards to the total weight of said aqueous solution, and 0.93 kg/h of NaCI (=MCl salt) were provided into a vessel and mixed together with a residence time of 120 minutes at a temperature of 34 °C.

The phosphate source had the same composition as the phosphate source used in example 1. Thus, the nH/nCa ratio was of 1.76 and the nMCl/nFSA ratio was of 2.56.

To measure the filterability, 236 g of the obtained slurry was filtered using a Buchner filter (same filtration conditions with same filter as in example 1). A vacuum of 450 mmHg was applied for the filtration. The filtration time recorded was 2 min 46 s, corresponding to a filterability of 3.2 g/dm²/s. 142 g of MCP filtrate (=liquid phosphate composition) were obtained, and 93.15 g of wet cake were obtained. After washing, the cake humidity was 18.5%.

The MCP filtrate contained 5.5 wt. % P₂O₅ based on the total weight of said MCP filtrate. The F content of the MCP filtrate was 0.02 wt. %, based on the total weight of said MCP filtrate.

The MCP filtrate comprised H₃PO₄ and H₂PO₄⁻, Ca⁺⁺ and H₃O⁺ ions. The filtration cake (=the solid residue) comprised 70 wt. % of sodium hexafluorosilicate. The filtration cake also contained other solid impurities, such as F, Al, Fe, heavy metals, Si, organic impurities, radioactive elements.

### Example 5—Preparation of DCP Dihydrate

469 g of MCP filtrate (=liquid phosphate composition) obtained from example 3 were mixed with 122 g of an aqueous solution containing 30 wt. % of CaCO₃, based on the total weight of said aqueous solution. The mixing was carried out at 40 °C, with a residence time of 30 min. In the obtained slurry, the pH was of 3 and the CaO/P₂O₅ molar ratio was 2. The obtained slurry was then filtered using a Buchner filter. A vacuum of 500 mmHg was applied. The filtration time recorded was 7 seconds. 48 g of filtrate and 99 g of wet DCP dihydrate cake were obtained (36% humidity). The DCP dihydrate composition contained, based on the total weight of said DCP dihydrate composition, 40 wt. % of phosphorus expressed as P₂O⁵ equivalents and 2.9 wt. % of F (on dry basis).

### Comparative Example 1

150 g of phosphate rocks (a phosphate source), 194 g of an aqueous solution comprising 37 wt. % of HCI with regards to the total weight of said aqueous solution, and 525 g of water were provided into a vessel.

The phosphate source had the same composition as the phosphate source used in example 1.

525 g of water were further added into said vessel. The content of the vessel was mixed for 30 min at a temperature of 50-55 °C (temperature of the content of the vessel).

The obtained slurry was filtered using a Buchner filter (same filtration conditions with same filter as in example 1). The calculated filterability was lower than 1 g/dm²/s. The filterability was thus lower than in the case of the examples according to the present invention.

### Comparative Example 2

150 g of phosphate rocks (a phosphate source), 568 g of an aqueous solution comprising 25 wt. % of FSA (an FSA source) with regards to the total weight of said aqueous solution, and were provided into a vessel.

The phosphate source had the same composition as the phosphate source used in example 1. Thus, the nH/nCa ratio was of 1.80 and the nMCl/nFSA ratio was of 0.00.

151 g of water were further added into said vessel. The content of the vessel was mixed for 30 min at a temperature of 50-55 °C (temperature of the content of the vessel). The obtained slurry was filtered using a Buchner filter (same filtration conditions with same filter as in example 1). The calculated filterability was lower than 2.3 g/dm²/s. The filterability was thus lower than in the case of the examples according to the present invention.

### Comparative /Example 3

200 g of phosphate rocks (a phosphate source), 442.6 g of an aqueous solution comprising 21.4 wt. % of FSA (an FSA source) with regards to the total weight of said aqueous solution, and 76.8 g of NaCI (MCl salt) were provided into a vessel and mixed. Then, 310.6 g of water and 129.7 g of an aqueous solution comprising 37 wt. % of HCI was added to the mixture.

The phosphate source had the same composition as the phosphate source used in example 1. Thus, the nH/nCa ratio was of 0.90 and the nMCl/nFSA ratio was of 2.00.

The content of the vessel was mixed for 30 min at a temperature of 45 °C (temperature of the content of the vessel). The obtained slurry was filtered using a Buchner filter (same filtration conditions with same filter as in example 1). A vacuum of 450 mmHg was applied for the filtration. The recorded filtration time in these conditions is 38 min, corresponding to a filterability lower than 1 g/dm²/s. At the end of the filtration, the obtained aqueous solution (liquid phosphate composition) comprised, based on the weight of said aqueous solution 5.2 wt. % of phosphorus expressed as P₂O₅ equivalents and 1.18 wt. % of F. The aqueous solution comprised H₃PO₄ and H₂PO₄⁻, Ca⁺⁺ and H₃O⁺ ions. The filtration cake (the solid residue) comprised 64 wt. % of sodium hexafluorosilicate. The filtration cake also contained other solid impurities, such as F, Al, Fe, heavy metals, Si, organic impurities, radioactive elements.

The table 1 below summarizes the conditions and the results of the examples and comparative examples above.

TABLE 1

| | | | | Wt. % of F |
|---|---|---|---|---|
| | | | | in the liquid |
| | nH/ | nMCI/ | Filterability | composition |
| | nCa | nFSA | (g/dm²/s) | after filtration |
| Example 1 | 1.80 | 2.20 | 3.2 | — |
| Example 2 | 1.80 | 2.00 | 3.3 | 1.24 |
| Example 3 | 1.80 | 2.20 | 3.4 | 0.4 |
| Example 4 | 1.76 | 2.56 | 3.2 | 0.02 |
| Comparative | 0.00 | N.A. | <1 | — |
| example 1 | | | | |
| Comparative | 1.80 | 0.00 | <2.3 | — |
| example 2 | | | | |
| Comparative | 0.90 | 2.00 | <1 | 1.18 |
| example 3 | | | | |

1. A process for preparing a liquid phosphate composition; said process comprising at least the steps of:
(i) providing in at least one vessel:
at least one phosphate source, and
either at least one salt selected from the group consisting of alkali chlorides, ammonium chloride and mixtures thereof [hereafter, MCl salt] and at least one fluosilicic acid [hereafter FSA] source, or
at least one composition [hereafter, composition (A)] obtained by contacting at least one MCl salt with at least one FSA source;
(ii) contacting said phosphate source with either said MCl salt and said FSA source, or with said composition (A), thereby forming at least one slurry comprising at least one solid residue and a liquid phosphate composition;
(iii) separating said solid residue from said liquid phosphate composition;
wherein the nH/nCa ratio is of at least 1.0, wherein nH is either the total amount of moles of hydrogen atoms from the FSA comprised in said FSA source provided in step (i) or from the FSA comprised in said FSA source used to obtain said composition (A), and nCa is the total amount of moles of Ca atoms comprised in said phosphate source provided in step (i); and wherein the nMCl/nFSA ratio is of at least 1.80; wherein nMCl is the total amount of moles of MCl salt provided in step (i) or used to obtained said composition (A) and nFSA is the total amount of moles of FSA comprised in said FSA source provided in step (i) or used to obtained said composition (A).

2. The process according to claim 1, wherein said nMCl/nFSA ratio is of at least 1.85.

3. The process according to claim 1, wherein said nH/nCa ratio is of at least 1.2.

4. The process according to claim 1, wherein said phosphate source comprises at least 10 wt. % of phosphorus expressed as P₂O₅ equivalents, with regards to the total weight of said phosphate source.

5. The process according to claim 1, wherein said liquid phosphate composition comprises, based on the total weight of said liquid phosphate composition, at least 0.5 wt. % of phosphorus expressed as P₂O₅ equivalents and at most 20 wt. % of phosphorus expressed as P₂O₅ equivalents.

6. The process according to claim 1, wherein said solid residue can comprise based on the total weight of said residue at least 10 wt. % of an hexafluorosilicate selected from the group consisting of ammonium hexafluorosilicate, alkali metal hexafluorosilicates and mixtures thereof; and said alkali metal is selected from the group consisting of Li, Na, K and combinations thereof.

7. The process according to claim 1, wherein steps (i) and/or (ii) are carried out at a temperature of at least 15 °C.

8. The process according to claim 1, wherein step (iii) is a filtering step.

9. The process according to claim 1, wherein said phosphate source is selected from the group consisting of phosphates rocks, ores comprising apatite, ores comprising hydroxyapatite, ores comprising chlorapatite, whitlockite, guano, carbonate apatite, phosphate slimes, beneficiation residue, ash sludges from wastewater treatment plants, bone ashes, solid industrial wastes from the pharmaceutical and food industries, and mixtures thereof.

10. The process according to claim 1, wherein said liquid phosphate composition obtained in step (iii) comprises, based on the total weight of said liquid phosphate composition, at most 4 wt. % of F.

11. (canceled)

12. A process for preparing a solid dicalcium phosphate [hereafter, DCP] composition comprising at least:
steps (i), (ii) and (iii) as defined in claim 1;
a step (iv) of contacting at least one basic composition with said at least one liquid phosphate composition at a pH sufficient to precipitate DCP, thereby forming at least one composition (C) comprising at least one solid DCP composition and a liquid phase;
a solid/liquid separation step (v) of the solid DCP composition from the liquid phase comprised in said composition (C), thereby obtaining the DCP composition.

13. The process for preparing a solid DCP composition according to claim 12, wherein said pH in step (iv) is of at least 1.

14. The process for preparing a solid DCP composition according to claim 12, wherein said calcic compound is selected from the group consisting of CaCO₃, CaO, Ca(OH)₂ and mixtures thereof.

15. The process for preparing a solid DCP composition according to claim 12, wherein said solid DCP composition comprises based on the total weight of said solid DCP composition, at least 15 wt. % of phosphorus expressed as P₂O₅ equivalents and at most 45 wt. % of phosphorus expressed as P₂O₅ equivalents and at most 5 wt. % of F.
